(19) United States
(12) Patent Application Publication
(10) Pub. No.: US 2005/0211097 A1
(43) Pub. Date: Sep. 29, 2005

(54) Apparatus for permeate side sweep of fiber membrane permeators

(76) Inventors: Thomas Eckman, Charlottesville, VA (US); Sandeep K. Karode, Boothwyn, PA (US); Kenneth R. Heath, Port Deposit, MD (US)

Correspondence Address: Air Liquide - Linda K. Russell, Suite 1800, 2700 Post Oak Blvd., Houston, TX, 77056, US

(21) Appl. No.: 10/879,282

(22) Filed: Jun. 29, 2004

Related U.S. Application Data
(60) Provisional application No. 60/556,865, filed on Mar. 26, 2004.

(51) Int. Cl. B01D 53/22

(52) U.S. Cl. 96/8

(57) ABSTRACT

This disclosure discusses devices to sweep the permeate side of fiber membrane permeators. Specifically, providing permeate side sweep wherein the fiber membranes comprise a bore; the feed fluid is in fluid communication with the outer surface of the fiber membrane; and the permeate is withdrawn from the bore of the fiber membrane. Permeate side sweep is used to increase the amount of permeate separated from a fluid mixture by the permeator device. The device of the subject invention includes a sweep chamber in fluid communication with the bore of the fiber membrane and in fluid communication with a suitable sweep fluid source. The sweep fluid is controllable and can be conditioned by devices known in the art.

### CROSS-REFERENCES

This application is related to and claims the benefit of U.S. Provisional Application No. 60/556,865, filed Mar. 26, 2004, entitled “Device To Enable Permeate Side Sweep (Internal and External) Of Hollow-fiber Gas Separation Membrane Modules.”

### BACKGROUND

Fluid separation fiber membrane permeators as described in U.S. Pat. Nos. 4,670,145 and 5,013,331 are used for industrial separation of components of fluid mixtures. These permeators comprise fiber membranes that selectively allow particular components of a fluid mixture to pass through the membrane. These fiber membranes comprise an inner bore and an outer surface, thus providing two regions for fluid mixture flow separated by the membrane. The initial fluid mixture, which will be separated, is the “feed fluid.” A component of the fluid passing through the fiber membrane is referred to as the “permeate,” while the remaining mixture is referred to as the “residue” fluid. The side of the membrane on which the feed mixture passes is referred to as the “feed side.” The side of the membrane on which the permeate exists is referred to as the “permeate side.” A “fiber membrane module” comprises one or more fiber membranes.

For certain applications, the feed side and permeate side pressures are not substantially different. In these applications, a fiber membrane module with permeate side sweep as described in U.S. Pat. No. 5,314,528 can significantly enhance the amount of permeate recovered by the fiber membrane module. A permeate side sweep “sweeps” a fluid of relatively low permeate content on the permeate side, lowering the permeate partial pressure on the permeate side and causing the fiber membrane module to pass significantly more of the desired permeate, but at a lower purity than would occur without the permeate side sweep. A device utilizing a permeate side sweep with the feed fluid in communication with the bores of fiber membranes and a permeate side sweep of the outer surface of the hollow fibers is disclosed in U.S. Pat. No. 5,525,143.

Previously disclosed permeate side sweep devices involve multiple-membrane fiber membrane modules in which feed is fed to the membrane bores (the feed side is the membrane bore), and the permeate side is the outer surface of the membranes. Additionally, such previously disclosed devices only provide a single permeate side sweep stage, allowing for higher permeate fluid yield only by operating at higher flow rates, which may be impractical, or by increasing the volume, and thus the relative size, of the fiber membrane module, which may also be impractical.

However, it is desirable to provide a permeate side sweep with the membrane bores as the permeate side, because the membrane bores comprise a smaller relative volume than the volume around the outer surfaces of the membranes. Such an application may reduce the required volume of sweep fluid. Additionally, such smaller volumes may provide enhanced control of the partial pressures of the sweep fluid and the permeate. Further, providing a device with multiple stages of permeate side sweep can provide incrementally higher permeate fluid yield over existing devices.

Accordingly, it is a goal of the invention to provide a permeate side sweep device allowing for use of the membrane bores as the permeate side, and to provide for control of the sweep fluid to such a device.

It is a further goal of the invention to provide a device with multiple stages involving permeate side sweep to enhance the yield or flow rate of the permeate fluid.

### SUMMARY

The present invention is directed to a device that satisfies the need to feed sweep fluid to the bores of fiber membranes, control the sweep fluid feed, and feed the sweep fluid to multiple fiber membrane modules. A permeator device having features of the present invention comprises one or more fiber membranes, each of which comprises a bore, a feed fluid in partial fluid communication with the bores, a sweep chamber in fluid communication with the bore, and a sweep fluid source in fluid communication with the sweep chamber.

Feeding a sweep fluid down the bores of fiber membrane permeators increases the amount of permeate exiting the permeator device. In this application, a fiber membrane permeator refers to a permeator device comprising at least one fiber membrane comprising a bore. In the preferred embodiment, a fiber membrane permeator additionally comprises a seal, a permeate chamber, a permeate port, and a residue port. Typically, but not necessarily, the fiber membrane module comprises a plurality of permeable fiber membranes of a type well known in the art comprising an outer surface and a bore. The seal, for example a tubesheet, prevents fluid in communication with the outer surfaces of the fiber membranes from flowing into the bores of the fiber membranes. One skilled in the art knows how to construct various configurations of fiber membrane permeators or fiber membrane modules with the components above as shown in U.S. Pat. Nos. 4,670,145 and 4,080,296.

The present invention comprises a fiber membrane module, a feed fluid in partial fluid communication with the bore of the fiber membrane, a sweep chamber in fluid communication with the bore of the fiber membrane, and a sweep fluid source in fluid communication with the sweep chamber. The feed fluid is a multi-component feed stock which is separated into a desired permeate and a residue. The partial fluid communication of the feed fluid with the bore of the fiber membrane separates the permeate, which passes through the wall of the fiber membrane into the bore of the fiber membrane.

The apparatus is used to increase the amount of permeate separated from the feed fluid by passing sweep fluid, of relatively low permeate content, to the permeate side (that is, the bore) of the fiber membrane. The fiber membrane selectively allows the permeate into the bore. However, the rate at which permeate can reach the bore is determined by the relative permeate partial pressure on either side of the fiber membrane. As permeate enters the bore through the membrane, the relative permeate partial pressure increases until a steady state is reached. If the permeate partial pressure within the bore is high, that is, when the permeate within the bore is of high purity, flow of permeate across the fiber membrane into the bore is limited. Introducing sweep fluid, such as residue fluid, into the bore lowers the partial pressure of the permeate in the bore and allows a higher rate of permeate flow across the fiber membrane into the bore.

The permeate and sweep fluids are withdrawn through the permeate port. In the preferred embodiment, the sweep fluid source is controllable, so that the amount or flow rate of the sweep fluid through the bore can be adjusted. Additionally, the sweep fluid may be conditioned in a conditioning system before being fed to the sweep chamber. Conditioning may comprise filtering, treating, changing the composition of, or otherwise modifying the sweep fluid by placing various devices, such as filters, separators, or other devices in fluid communication with the sweep conduit.

Because fiber membrane permeators often contain a number of fiber membrane modules in one device, various embodiments of the invention may comprise various combinations of sweep fluid sources, conditioning of the sweep fluid, or controlling the sweep fluid to each fiber membrane module individually, to all fiber membrane modules jointly, or any combination of individual and joint sweep fluid feed depending on the needs of the application.

The apparatus has the advantage of providing a simple and economical apparatus for implementing a permeate side sweep of a fiber membrane permeator in which the permeate is in fluid communication with the bore of the fiber membrane and the feed fluid is in fluid communication with the outer surface of the fiber membrane. Preferred embodiments provide the advantages of conditioning or controlling the sweep flow, thus controlling the quantity and purity of permeate fluid exiting the fiber membrane permeator. By increasing the amount of sweep fluid (through increasing the flow rate or pressure of the sweep fluid), the fiber membrane permeator typically produces a larger quantity of permeate, but at a lower purity level.

Alternately, reducing the amount of sweep fluid typically causes the fiber membrane permeator to produce less permeate at a higher purity.

One embodiment of the device includes the ability to feed sweep fluid to each fiber membrane module individually. Feeding fiber membrane modules individually allows the practitioner maximum flexibility to optimize the amount and purity of permeate withdrawn from the fiber membrane permeator. The practitioner can vary the sweep flow to the individual fiber membrane modules, provide different sweep fluid sources to different fiber membrane modules, or condition the sweep fluid differently to different fiber membrane modules.

As indicated above, another advantage of the apparatus is the ability to place the sweep chambers in fluid communication with different sweep fluid sources. The preferred sweep fluid source is the residue exiting the permeator. However, significant advantages can be obtained using other fluid streams available to the practitioner for the sweep fluid source that result in higher permeate production, greater overall system efficiencies, or lower operating costs. For instance, the practitioner may have a separate or related process from which there is an excess of a stream low in permeate content that can be used as the sweep fluid source. Furthermore, feeding each fiber membrane module individually provides an advantage by allowing the practitioner to further optimize the permeation process by feeding residue fluid to some of the fiber membrane modules, while feeding a sweep fluid from another source to other fiber membrane modules.

### DESCRIPTION OF THE DRAWINGS

FIG. 1 is a sectional view of one embodiment of a fiber membrane permeator of the present invention.

FIG. 1A is a side view of segment A-A′ of FIG. 1, showing detail of the fiber membrane module.

FIG. 2 is a sectional view of a multi-module embodiment of the present invention.

FIG. 3 is a sectional view of an alternative embodiment of the multi-module embodiment of FIG. 2.

FIG. 4 is a sectional detail view of one embodiment of a sweep fluid source of the present invention.

### DESCRIPTION

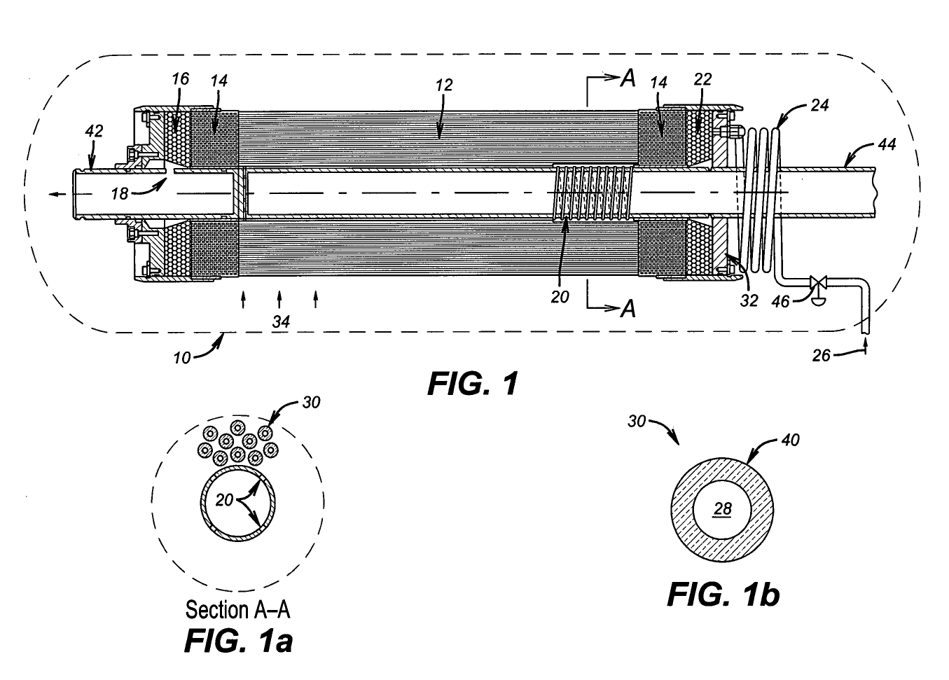

Referring to FIGS. 1 and 1A, one embodiment of a fiber membrane permeator 10 with permeate side sweep of the fiber membrane bores comprises a fiber membrane module 12 with a seal 14, a permeate chamber 16, a permeate port 18, a residue port 20, a sweep chamber 22, a sweep conduit 24 and a sweep fluid source 26. The permeate chamber 16 is sealingly engaged with the seal 14 and in fluid communication with the bores 28 of the fiber membranes 30. The sweep chamber 22 comprises a chamber cap 32 sealingly engaged with the seal 14 of the fiber membrane module 12 to create a sealed volume in fluid communication with the bores 28 of the fiber membranes 30. The sweep conduit 24 is in fluid communication with the sweep fluid source 26 and the sweep chamber 22.

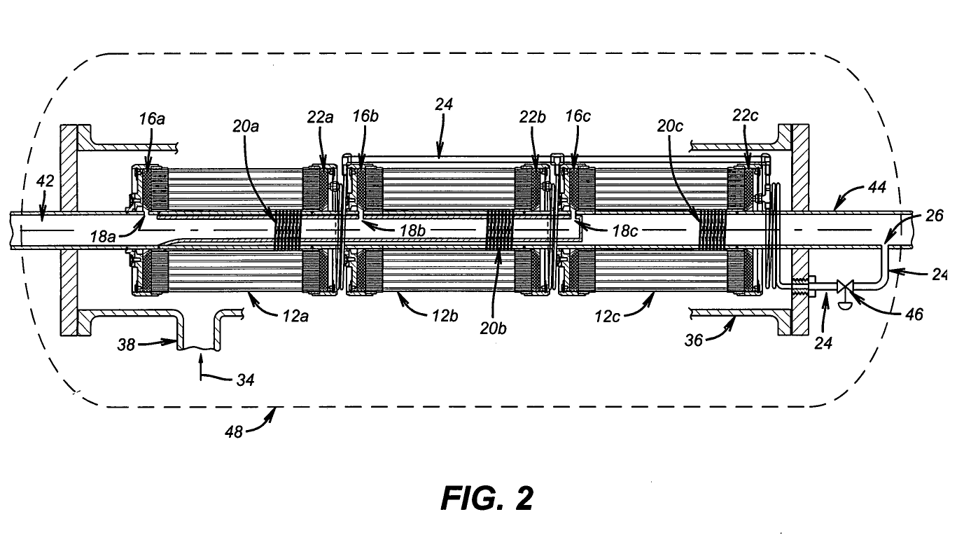

One skilled in the art will recognize that there are various configurations of supplying feed fluid 34 to the fiber membrane permeator 10. For example, in the preferred embodiment of FIG. 2, the fiber membrane modules 12a,b,c are in a housing 36 and the feed fluid 34 is in fluid communication with a feed port 38 of the housing 36. It is also possible to place the fiber membrane permeator 10 directly in a reservoir of feed fluid (not shown) exposing the outer surface 40 of the fiber membrane 30 directly to the feed fluid 34. This invention is applicable to any configuration wherein the feed fluid 34 is in fluid communication with the outer surface 40 of the fiber membrane 30.

Referring again to FIG. 1, the permeate port 18 is in fluid communication with the permeate chamber 16 and in fluid communication with the permeate conduit 42 allowing withdrawal of the permeate from the fiber membrane permeator 10. The residue port 20 is in partial fluid communication with the feed fluid 34. As depicted in FIG. 1, the residue port 20 is in the annulus of a round bundle of fiber membranes 30. However, other configurations may be used without departing from the spirit of the invention. The residue port 20 is in fluid communication with the residue conduit 44. The residue conduit 44 allows withdrawal of the residue from the fiber membrane permeator 10.

Still referring to FIG. 1, fluid communication between the sweep chamber 22 and the sweep fluid source 26 is via a sweep conduit 24. The sweep fluid source 26 is any suitable source of fluid. The preferred sweep fluid source 26 has a content of the permeated component that is lower than the content of the permeate exiting the fiber membrane permeator 10. In the preferred embodiment of FIG. 2, the sweep fluid source 26 is the residue ports 20a,b,c. The sweep chamber 22 is in fluid communication with the residue ports 20a,b,c via a sweep conduit 24 that is in fluid communication with the residue conduit 44.

Referring again to the preferred embodiment of FIG. 1, the fluid communication between the sweep fluid source 26 and the sweep chamber 22 is controllable by a sweep control device 46. The sweep control device 46 can be by any device or method known to one skilled in the art. The sweep control device 46 is in fluid communication with the sweep conduit 24 that is in fluid communication with the sweep fluid source 26 and the sweep chamber 22. Another embodiment (not shown) would use a method of calculating the size of the sweep conduit 24 to control the flow of sweep fluid to the sweep chamber 22 by the pressure drop of the fluid in the sweep conduit 24.

The preferred embodiment of FIG. 2 shows a plurality of fiber membrane modules 12a,b,c stacked to form a multi-module fiber membrane permeator 48. One skilled in the art can construct a multi-module fiber membrane permeator 48 comprising a plurality of fiber membrane modules 12a,b,c. Typically, but not necessarily, the permeate side of the fiber membrane modules 12a,b,c are in fluid communication with a plurality of permeate ports 18a,b,c that are in fluid communication with a permeate conduit 42. The residue side of the fiber membrane modules 12a,b,c are in fluid communication with a common residue conduit 44 through their respective residue ports 20a,b,c.

Still referring to FIG. 2, a plurality of the sweep chambers 22a,b,c are in fluid communication with a common sweep conduit 24 and sweep fluid source 26. A common sweep conduit 24 is in fluid communication with the residue conduit 44. Thus the residue conduit 44 is the sweep fluid source 26. A common sweep control device 46 in fluid communication with the sweep conduit 24 controls the sweep fluid to all sweep chambers 22a,b,c.

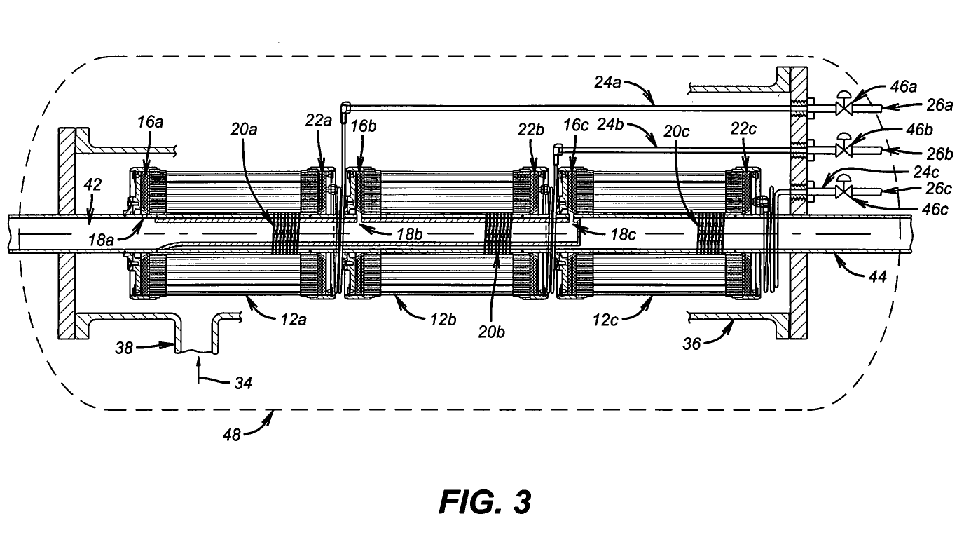

In the preferred embodiment of FIG. 3, a plurality of sweep chambers 22a,b,c, are in fluid communication with a plurality of sweep fluid sources 26a,b,c. There are separate sweep control devices 46a,b,c in each sweep conduit 24a,b,c. The sweep control devices 46a,b,c control the fluid communication between the sweep chambers 22a,b,c and the sweep fluid sources 26a,b,c individually. One skilled in the art will recognize many combinations wherein some of the sweep chambers 22a,b,c are in fluid communication with individual sweep fluid sources 26a,b,c as shown in FIG. 3, and some of the sweep chambers 22a,b,c are in fluid communication with a common sweep fluid source 26 as shown in FIG. 2.

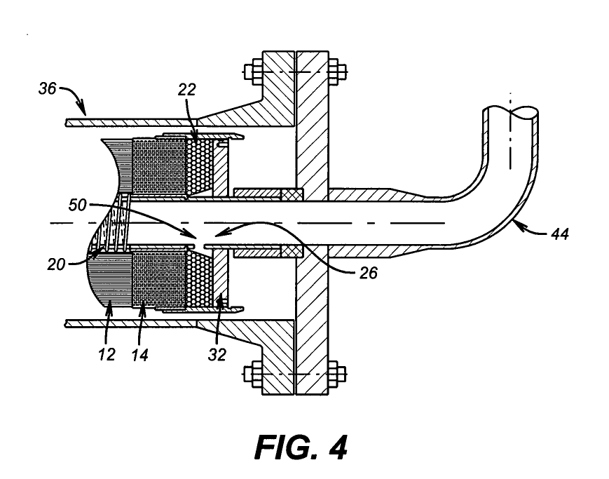

The preferred embodiment of FIG. 4 comprises a fiber membrane module 12 with a permeate chamber (not shown) in fluid communication with the bores 28 of the fiber membranes 30. The embodiment further comprises a permeate port (not shown), a residue port 20, and a sweep chamber 22. The sweep chamber 22 comprises a chamber cap 32 sealingly engaged with the seal 14 of the fiber membrane module 12 to create a sealed volume in fluid communication with the bores 28 of the fiber membranes 30. An orifice 50 provides the fluid communication between the sweep fluid source 26 and the sweep chamber 22. Thus the sweep fluid source 26 is in fluid communication with the residue port 20.

Although the present invention has been described in considerable detail with reference to certain preferred versions thereof, other versions are possible. For example, a permeator may contain single or multiple fiber membrane modules in arrangements other than the arrangements shown. Likewise, the device may or may not contain a sweep conduit. Furthermore, a sweep conduit, if provided, may vary in construction such as piping, tubing, or conduits integral to a permeator housing. There are also a variety of devices known in the art to control the flow or pressure of the sweep fluid such as self contained regulators, pressure control valves, flow orifices, flow control valves, or flow valves mounted in flow conduits integral to a permeator housing. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

1. A device for selectively separating components from a fluid mixture comprising:
a fiber membrane, comprising a bore;
a feed fluid in partial fluid communication with said bore;
a sweep chamber in fluid communication with said bore; and
a sweep fluid source in fluid communication with said sweep chamber.

2. The device of claim 1, wherein fluid communication between said sweep fluid source and said sweep chamber is controllable.

3. The device of claim 1, wherein said sweep fluid source comprises a residue port.

4. The device of claim 1, further comprising a conditioning system in fluid communication with said sweep fluid source.

5. A multi-module permeator device for selectively separating components from a fluid mixture comprising a plurality of permeators, wherein each of said permeators comprises:
a fiber membrane, comprising a bore;
a feed fluid in partial fluid communication with said bore;
a sweep chamber in fluid communication with said bore; and
a sweep fluid source in fluid communication with said sweep chamber.

6. The device of claim 5, wherein at least one of said sweep fluid sources comprises a residue port.

7. The device of claim 5, further comprising a conditioning system in fluid communication with at least one of said sweep fluid sources.

8. The device of claim 5, wherein fluid communication between at least one of said sweep fluid sources and its respective sweep chamber is controllable.

9. The apparatus of claim 8, wherein fluid communication between said sweep fluid sources and said sweep chambers is simultaneously controllable.

10. The apparatus of claim 8, wherein fluid communication between said sweep fluid source and said sweep chamber in each of said permeators is individually controllable.
